(19) United States
(12) Patent Application Publication
(10) Pub. No.: US 2005/0097104 A1
(43) Pub. Date: May 5, 2005

(54) System and method for identification of objects

(76) Inventors: Gary Robinson, Moore, OK (US); Steve Thompson, Moore, OK (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/698,631

(22) Filed: Oct. 31, 2003

(51) Int. Cl. G06F 17/30

(52) U.S. Cl. 707/7; 707/3

(57) ABSTRACT

The application relates to a system and method for identification of parts. In one preferred embodiment the invention is used for the identification of machined parts such as those used in automobiles, and other relatively complex machinery. The system includes a scalable database of identification data sets. Each data set is descriptive of an item and comprises information that aid in identifying the item including data relating to a numbering scheme, a family category, picture files depicting the item, and identification criteria defined from the family category. The system presents an input screen having a plurality of input boxes to a user display screen, including input boxes for input of a number scheme and a family wizard. Upon receiving user input from an input device, the system retrieves at least one data set descriptive of an item from the database based upon input received. The system is also configured to present a criteria screen, upon receiving input from the user device selecting a family wizard. The criteria screen includes identification questions that correlate to the identification criteria for the corresponding family. The system can also present a results screen that include all of the information from at least one data set.

### BACKGROUND OF THE INVENTION

This invention relates generally to identification of objects and, more particularly, to apparatus and methods for identification of manufactured parts, such as transmissions and other manufactured parts, through visual inspection.

When manufactured goods fail, they can often be repaired. For example, when an automotive part such as a transmission or engine fails, typically only a few components of the part require replacement, whereas the rest of the part remains operable. Correct identification of the failed part is imperative if repair is to be successful. However, parts are frequently misidentified, resulting in economic loss of considerable magnitude, particularly when the part is complex, as in machinery.

In the automotive field, failed parts are frequently sent to facilities owned by third parties that remanufacture, refurbish, or repair failed parts. Such facilities receive a substantial number and variety of automotive parts for repair. For example, a typical repair facility may repair many thousands of transmissions per year. In addition, such facilities are typically configured to handle several hundred different variations of transmissions. Thus, a critical aspect of the repair and refurbishment process is to properly identify and sort the failed parts. Correct identification of failed parts is also important to insure that the cost of repairing parts is correctly allocated among the owner of the part and the repair facility. Today, losses sustained due to misidentification of parts are in the millions of dollars each year. The problem of misidentification is exacerbated by the practice of shipping failed parts to third party repair facilities, because a misidentified part is worthless when sent to a facility that is not equipped to repair that part.

Automobile transmissions, as well as other kinds of complex machinery, are sometimes identifiable by indicia stamped or otherwise marked on the part. However, this information is generally not known or understood by the workers who repair the parts at a repair facility. While some parts may be identified by labels affixed to them by the manufacturer, it is often true that parts cannot be identified in this manner. For example, not all parts are marked with a part number. Moreover, on a certain percentage of parts received for refurbishment, labels once present are unreadable or missing entirely, thereby requiring identification by other means.

Other techniques for identification of parts require familiarity with the replacement parts, including model numbers and variants. Such techniques are impractical when the parts are complex. In some instances, it is simply impractical to identify unmarked parts, resulting in an ineffective use of materials and creating environmental concerns. Similar issues arise in the repair and refurbishment of other parts, such as engines, braking assemblies, and the like.

An additional issue addressed by the present invention is the need to accurately credit and value parts sent to third parties for repair or refurbishment. As previously mentioned, when a major assembly, such as a transmission, engine or brake assembly, fails, the entire assembly is often removed and replaced with a previously repaired or refurbished assembly. The removed, failed assembly is generally shipped to a third party business for repair. The original manufacturer of the assembly credits the third party repair facility for the residual value of the repaired part—in effect, purchasing the repaired assembly—for subsequent resale to authorized vendors of repaired parts. The residual value of a failed assembly is referred to in the automotive industry as the “core charge” for the assembly or part, as the case may be. The part or assembly may be referred to simply as “core.” It is apparent that misidentification of failed parts and assemblies in the above-described process results in considerable economic loss to the manufacturers if the core charge is credited to the repair facility but repair is impossible because the part, through misidentification, has been sent to a facility not equipped to repair that part.

It is therefore evident that there is a need for a cost-effective approach for identifying manufactured objects in an efficient and accurate manner while at the same time improving accountability. Such an approach would have particular application to the automotive industry for identification of parts used in automotive transmissions, engines and brake assemblies. The present invention fulfills these needs and others.

### SUMMARY OF THE INVENTION

The present invention relates to a system and method for efficient identification of parts for manufactured objects, such as transmissions and engines. The system includes a scalable database of identification data sets. Each data set is descriptive of an item and comprises information that aids in identifying the item including data relating to a numbering scheme, a family category, picture files depicting the item, and identification criteria defined from the family category. The system presents an input screen having a plurality of input boxes to a user display screen, including input boxes for input of a number scheme and a family wizard. Upon receiving user input from an input device, the system retrieves at least one data set descriptive of an item from the database based upon input received. The system is also configured to present a criteria screen, upon receiving input from the user device selecting a family wizard. The criteria screen includes identification questions that correlate to the identification criteria for the corresponding family. The system can also present a results screen that include all of the information from at least one data set.

In one preferred embodiment of the invention, system and method are provided for identification of parts wherein a user is afforded a choice of approaches for identification. For example, a user can search based upon the number scheme associated with the part or based upon the identification criteria. Moreover, the data sets can further include data relating to ownership, size, sort code, supplier and product line of the item.

In yet another detailed aspect of a preferred embodiment, the system transmits information from at least one server to users by way of the Internet, an intranet, or similar technology. Broadcast of centrally-stored information to other facilities reduces the cost of information storage while allowing for rapid update of data without loss of security for proprietary information.

Although embodiments of the invention are illustrated and described with reference to parts for automobile transmissions, those skilled in the relevant fields will readily recognize application of the invention to other manufactured parts, for example, motorcycles, marine and aircraft parts, as well as electrical motors for industry and related controllers. Accordingly, the scope and applicability of the invention should be understood to be broader than the embodiments illustrated and disclosed herein.

Other features and advantages of the invention will become apparent from the following description of the preferred embodiments, taken in conjunction with the accompanying drawings, which illustrate, by way of example, the principles of the invention.

### BRIEF DESCRIPTION OF THE DRAWINGS

Embodiments of the present invention will be described, by way of example only, with reference to the following drawings in which:

FIG. 1 is a simplified schematic of a network for identification of objects in accordance with the present invention. Several devices are shown in communication with one another by way of the Internet.

FIG. 2 is a simplified block diagram depicting a database schema implemented for the database of FIG. 1.

FIG. 3 is a Web page, or main menu, of the system of FIG. 1, which presents options for either initiating a search or system maintenance.

FIG. 4 is a Web page, or a look-up screen, of the system of FIG. 1, which presents input boxes by which a user can initiate identification of a part.

FIG. 5A is the look-up screen of FIG. 4, depicting a search initiated based upon a Service Part Number.

FIG. 5B is an item screen based upon the search initiated in FIG. 5A.

FIG. 6A is the look-up screen of FIG. 4, depicting a search initiated based upon selection from the Family menu.

FIG. 6B is a search results screen based upon the search initiated in FIG. 6A.

FIG. 7A is the look-up screen of FIG. 4, depicting a search initiated based upon selection from the Family Wizard menu.

FIG. 7B is a criteria screen based upon the Wizard initiated of FIG. 7A.

FIG. 7C is a results screen based upon the answers provided in the criteria screen of FIG. 7C.

FIG. 8 is a file maintenance screen for maintaining the database of FIG. 1

### DETAILED DESCRIPTION OF THE PREFERRED EMBODIMENTS

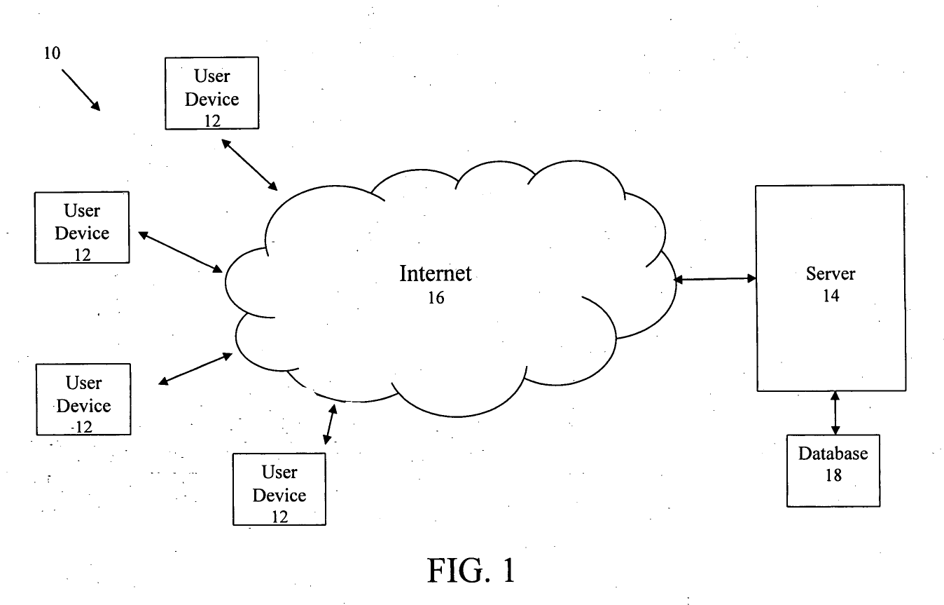

With reference now to the illustrative drawings, and particularly to FIG. 1, there is shown a simplified block diagram of an object identification system 10 including user devices 12 and an application server 14 in communication with one another, e.g., via Internet 16, enabling access to a relational database 18 of information for identification of parts. The system enables a user to quickly and accurately identify a part by a number of different approaches, thereby accommodating users with varied familiarity with identification of parts, ranging from users merely able to identify the family of parts (e.g., transmission, engine, etc.) to those with considerable familiarity with such parts. For example, the system allows the user to identify the parts by different numbering schemes used in the automotive industry. The system also allows users with limited experience to identify a part or assembly based on its appearance.

The user device 12 may be any Web-enabled device, such as a personal digital assistant (e.g., a PalmPilot, by Palm, Inc.), a personal computer or wireless telephone. The connections between these components are shown using a double-sided arrow and may be a physical, fiber optic, wireless, or any other type of link. Optionally, the Web site or other software embodiments of the system can be stored directly on a user device for access by a user in an off-line mode, as discussed in detail below. The server 14 hosts application files and a PHP scripting engine to facilitate interaction with the database 18. The database can be hosted by the server or on separate hardware in communication with the server.

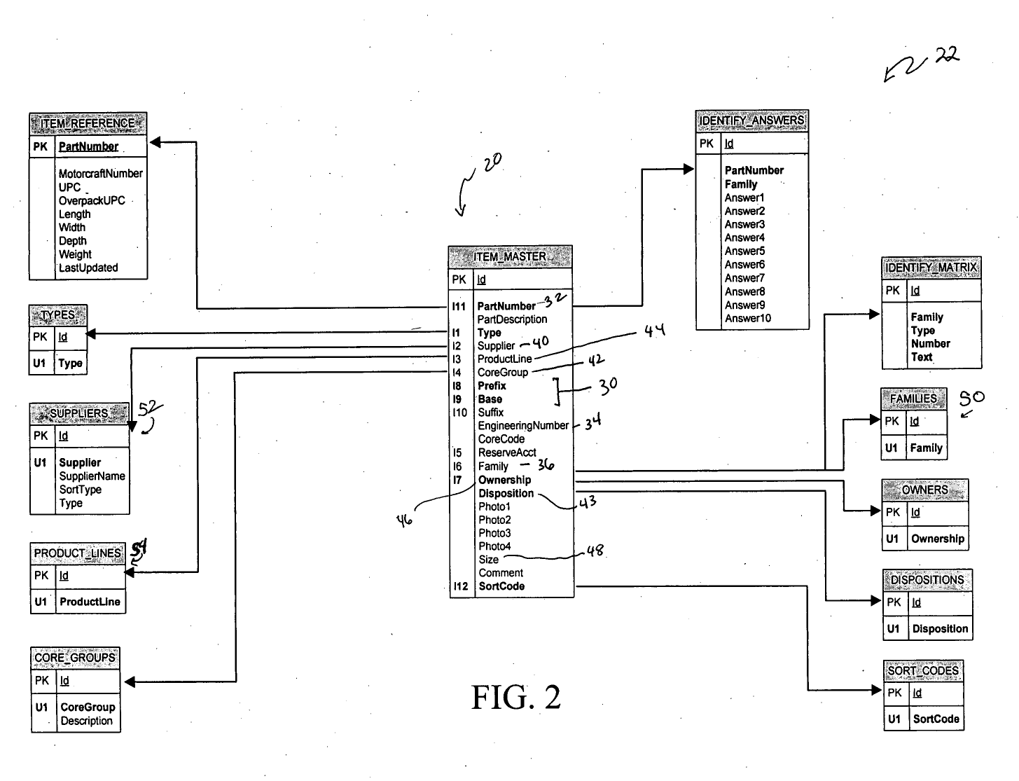

FIG. 2 depicts an exemplary schema 22 for data sets of the database. In the exemplary embodiment, the database is structured via a relational data base management system, such as MYSQL. The database is scalable and, in the presently preferred embodiment, is loaded with information for over 54 families of parts. The database includes data sets 20, identified as “Item_Master,” that include information descriptive of a particular item. In this embodiment, the database is configured for parts associated with the automotive industry, however, other embodiments are contemplated for other industries.

In this embodiment, each data set includes several different numbering schemes for identifying an item, including Prefix, Base and Suffix numbering system 30, Part Number 32, Engineering Part Number 34, which are discussed below. Each data set also includes additional designations for an item, e.g., family 36, supplier 40, core group 42, disposition 43, product line 44, ownership 46, size 48, as well as photo files of the item for visual comparison. Family designation 36 corresponds to one of the listed core family of the family 50 data sets shown in Table 1. The Supplier designation 38 corresponds to the remanufacturing supplier of a given part, available in the suppliers 52 data set. The Product Line menu 44 corresponds to product catalog designations of a given part, i.e., suppliers data set 54. Any particular item may or may not have data in each designation of its data set, depending upon applicability for that particular item.

TABLE 1
Core Families

| No. | Core Family |
|---|---|
| 1 | ABS Modules |
| 2 | AC Clutch |
| 3 | AC Compressor |
| 4 | Alternator |
| 5 | Automatic Transmissions |
| 6 | Brake Caliper |
| 7 | Clutches and Pressure Plates |
| 8 | Complete Engines (Gas) |
| 9 | Crankshafts |
| 10 | CV Half Shaft |
| 11 | Cylinder Heads |
| 12 | Distributors |
| 13 | Integral Gear |
| 14 | Manual Transmissions |
| 15 | Power Steering Pump |
| 16 | Rack & Pinion Gear |
| 17 | Starter |
| 18 | Torque Converters |
| 19 | Window Lift Motor |
| 20 | Wiper Motor |
| 21 | Water Pump |
| 22 | AC Accumulator and Hose |
| 23 | Blower Motor |
| 24 | Brake Boosters |
| 25 | Brake Pads |
| 26 | Brake Shoes |
| 27 | Camshafts |
| 28 | Catalytic Converter |
| 29 | Complete Engines (Diesel) |
| 30 | Diesel Fuel Nozzles & Holders |
| 31 | Diesel Injection Pumps |
| 32 | Electric Air Temp Control |
| 33 | Electric Seat Motor |
| 34 | Electronic Instrument Cluster |
| 35 | Engine Control Module EEC |
| 36 | Engine Fan Motor |
| 37 | Fuel Injector |
| 38 | Fuel Pump |
| 39 | Fuel Sender |
| 40 | GEM Module |
| 41 | Mass Air Flow Sensor |
| 42 | Master Brake Cylinder |
| 43 | Oil Pump |
| 44 | Power Antenna |
| 45 | Radios |
| 46 | Rear Axle |
| 47 | Speed Control |
| 48 | Strut - Front |
| 49 | Strut - Rear |
| 50 | Throttle Body |
| 51 | Transfer Case |
| 52 | Transmission Control Modules |
| 53 | Trip Computer |
| 54 | Turbo Chargers |

In one preferred embodiment of the invention, parts are organized by core families. The term “core” is used in its ordinary sense to refer to a foundational or fundamental part. In the preferred embodiment, there are fifty four (54) core families that describe the components of an automobile. Those skilled in manufacturing will recognize that core families can also be used to describe the organization of other manufactured parts, as well as parts made by different manufacturers.

Thus, the following detailed description is presented as an example, illustrating how the invention may be used, and should not be understood as limiting the scope of the invention.

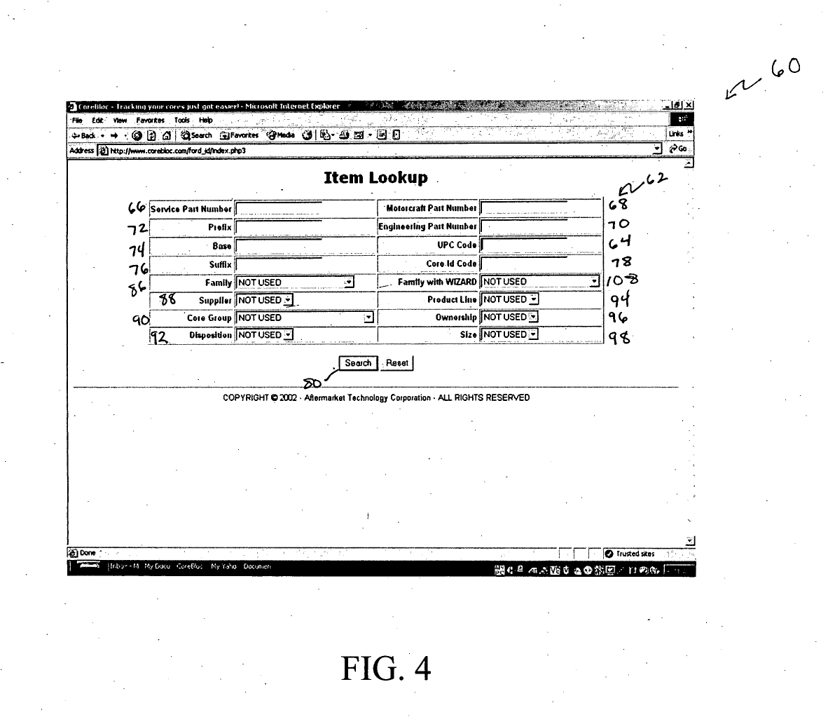

With reference now to FIG. 4, system 10 presents the user with a Web page 60, i.e., a look-up screen, that allows the user to initiate a search to identify a part by various methods of identification. These methods can be generally grouped into two approaches—a first approach based upon a number system or a second approach based upon other identification attributes. The look-up screen avails the user of both of these general approaches.

The look-up screen presents a plurality of input boxes 62 based upon one of several different numbering systems used in the automotive industry, including blocks for UPC Code 64, Service Part Number 66, Motorcraft® Part Number 68, Engineering Part Number 70. Each numbering system is geared toward a particular segment of the automotive industry and/or stage of the product lifecycle. As an example, The Motorcraft® Part Number may be used by the for aftermarket parts used in automobiles from Ford Motor Co., Inc. The Engineering Part Number is used by the engineering group of an automobile manufacturer Parts can be identified by make and model of the vehicle using the Prefix, Base and Suffix numbering system. In this numbering system, the Prefix 72 defines the year and model; the Base 74 defines the part type; and the Suffix 76 defines the part specifics, e.g., left v. right side of vehicle, etc. In addition, parts can be identified by UPC (Universal Product Code). Also, certain types of parts have codes, or other number systems, stamped or otherwise placed on the body of the part. The system of the present invention accommodates use of these systems via the Core Id Code 78 input block. Thus, if the user is sufficiently familiar with the part, and its various numbering systems, identification can be quickly accomplished.

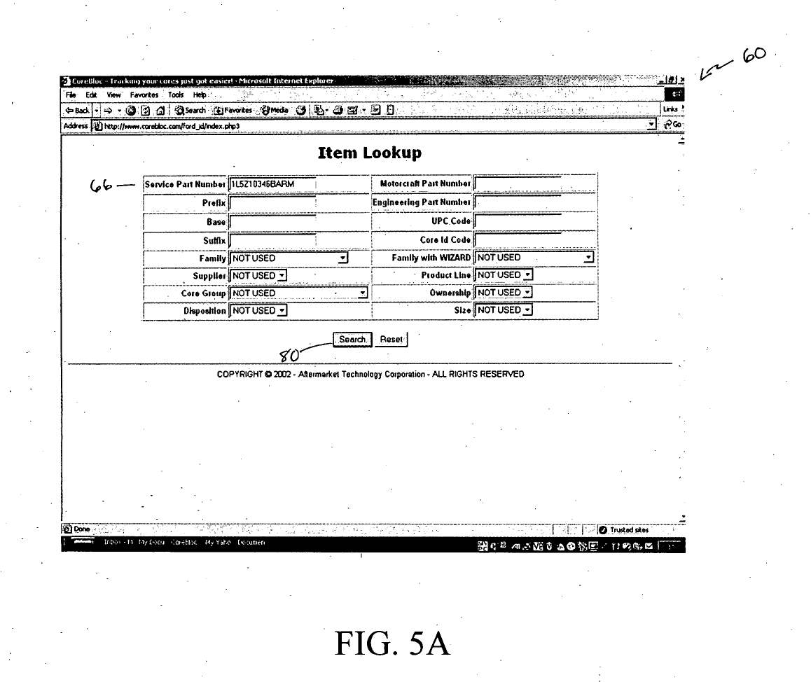

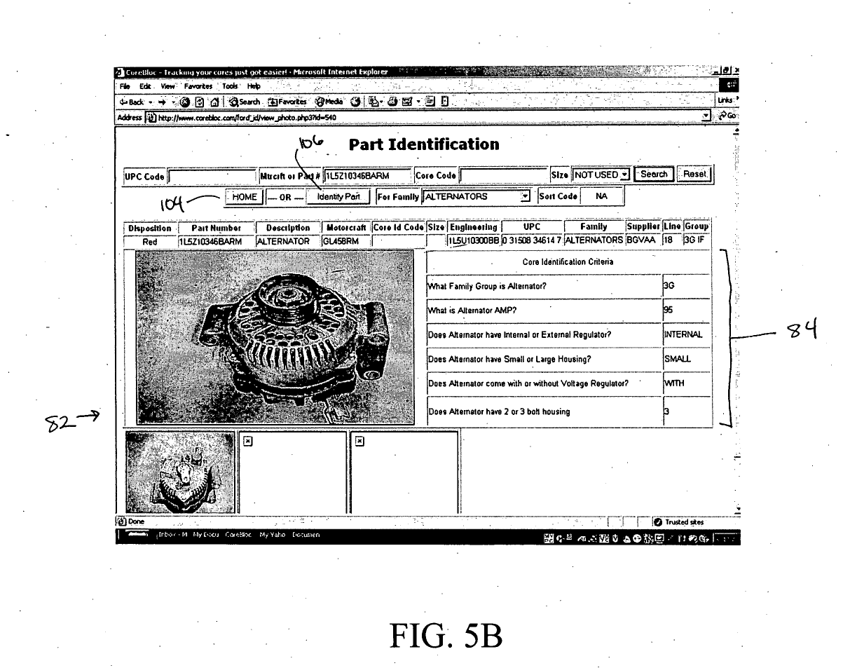

FIGS. 5A and 5B depict a search sequence using a service part number. As shown in FIG. 5A, the user inputs service part number “1L5Z10346BARM” and, thereafter, initiates the search by selecting the “search” icon 80. The system accesses the appropriate data set from the database and presents the information to the user in a part identification screen, as shown in FIG. 5B., including pictures 82 of the part and core identification criteria 84. This screen allows the user to verify the part by comparing it to the information presented, such as the pictures and any core identification criteria.

System 10 also provides efficient means of identification for users lacking familiarity with the aforementioned numbering systems. The look-up screen includes additional input boxes that provide drop-down menus, i.e., input menus, for selection by the user. These input menus represent various additional methods by which parts can be grouped. In this embodiment, the input menus includes the following menus: Family 86, Supplier 88, Core Group 90, Disposition 92, Product Line 94, Ownership 96, and Size 98. These menus correlate to corresponding data sets forth in the representative database schema depicted in FIG. 2.

With reference again to FIG. 4, the input boxes 62, including the menus, can be used singly, or in combination, to initiate identification. The Family menu 86 lists core families found in database 18. The Supplier menu 88 corresponds to the remanufacturing supplier of a given part. The Product Line menu 90 corresponds to product catalog designations of a given part.

A particular core family can be utilized to produce multiple different finished products. The Core Group menu lists these various groupings.

If known, the Ownership menu allows a user to tailor the identification search by selecting from a list of the party that owns the group in question (e.g., OEM, remanufacturer, supplier, etc.). The Disposition menu 92 lists various methods of disposition assignable for a given part, such as “RED” for Scrap, “GREEN” for shipment for remanufacturing, “HOLD” for hold for future disposition, and other unique sort identifiers. Notably, some cores are identifiable by size (e.g., clutch disks, etc.). The Size menu 98 allows the user to select for a list sizes, if known.

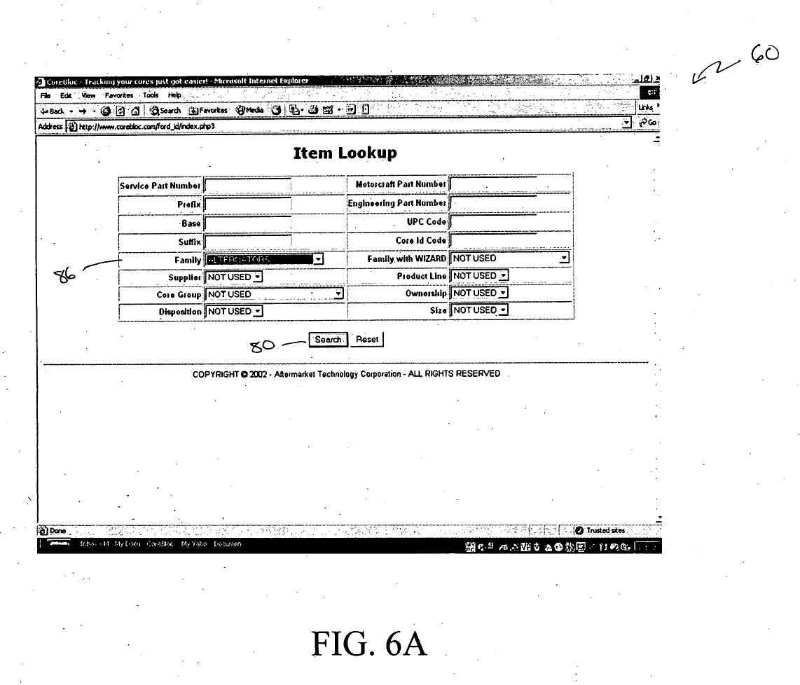

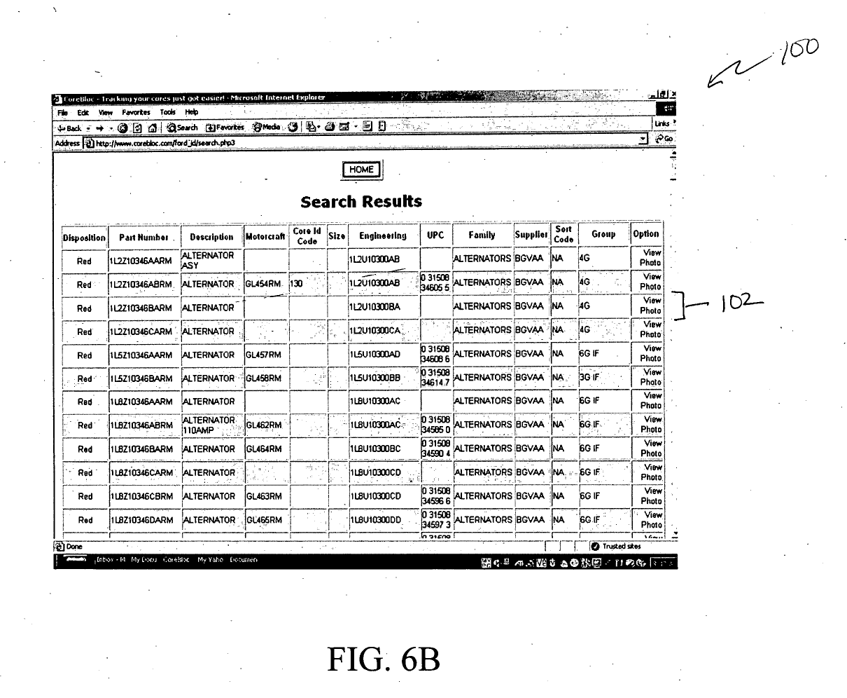

FIGS. 6A-6B depict a search sequence initiated by selecting a group from the Family menu 86. As shown in FIG. 6A, the user selects the “alternator” family and initiates the search by selecting the “search” icon 80. The system, then, lists all data sets from the database corresponding to the alternator family on a search results screen 100, as shown in FIG. 6B. From the search results screen, the user can select a data set for comparison. If, for example, the user selects data set 102, then the system will display the result screen shown in FIG. 5B. The user has several options at this point, if the part does not match the information displayed. For example, the user can (a) go back to the previous page and select another part, (b) initiate a new search by selecting the home icon 104, or (c) proceed to the Family Wizard by selecting the ‘identify part’ icon 106, discussed below.

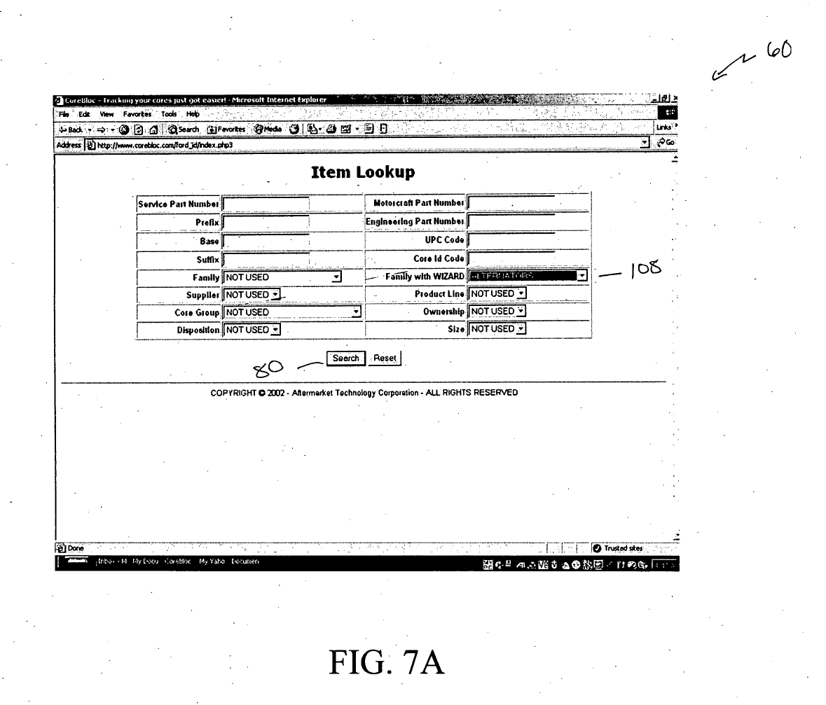

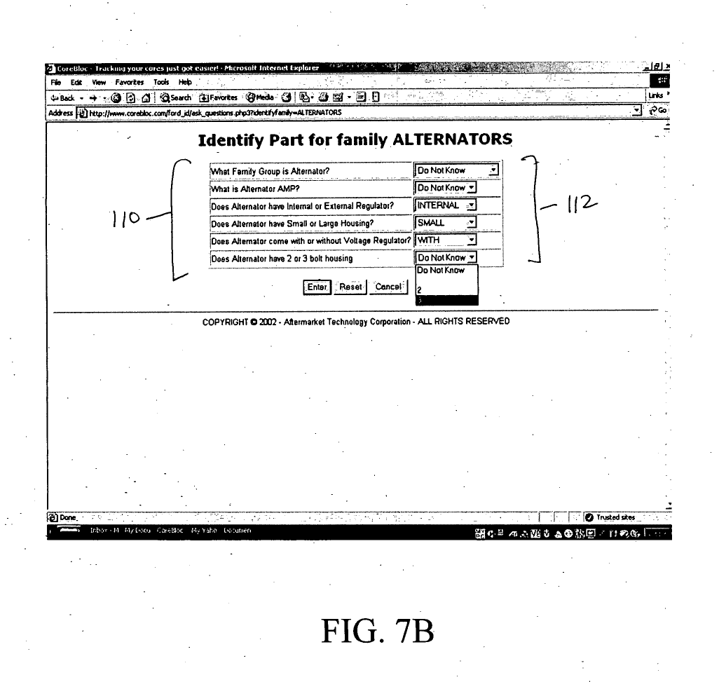

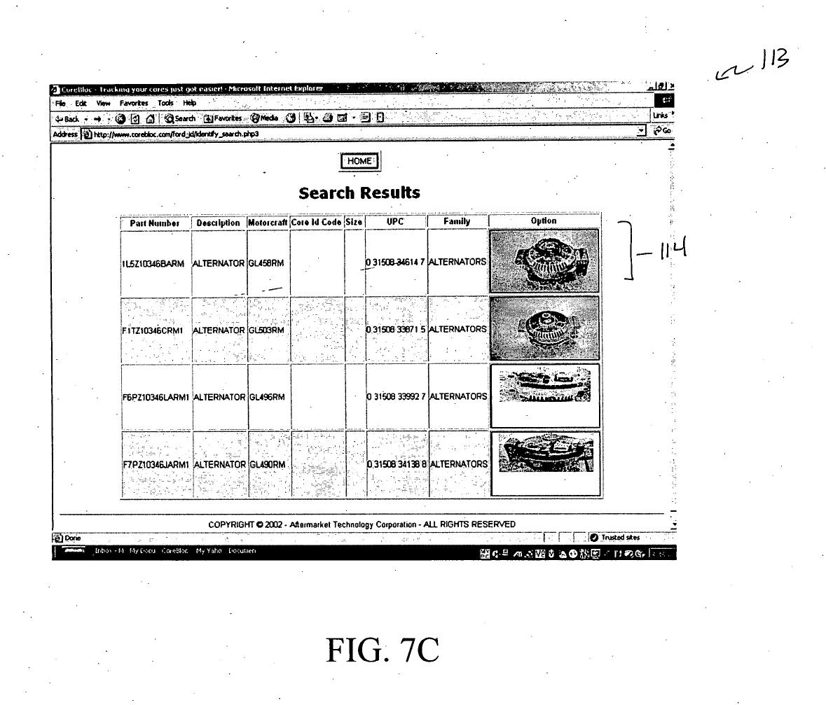

With reference again to FIG. 4, the look-up screen 60 includes a Family Wizard 108. The Family Wizard provides a drop down menu of all families found in the database 18. Upon selection of a family from the Family Wizard, the system presents a screen of attribute type questions (e.g., FIG. 7B). These questions are generally directed to visually observable characteristics of the selected core family.

FIGS. 7A-7C, depict a search sequence initiated via the Family Wizard menu. As shown in FIG. 7A, the user initiates this type of search by selecting a core family from the Wizard menu. In this example, the user selects the “alternator” family. Thereafter, the system presents a set of questions 1 10 directed to characteristics that aid in distinguishing various types of alternators from one another. Here, each question has an associated drop down menu 112 listing various responses to the question at hand. In this example, the user has answered four out of six of the questions based on visual inspection of the product (FIG. 7B). The system will then display the results of the attributes query. FIG. 7C depicts a search results screen 113 showing data sets, including pictures, corresponding to parts having the attributes identified by the user. Selection of the first alternator 114 of the list will take the user to the corresponding parts screen, as shown in FIG. 5B.

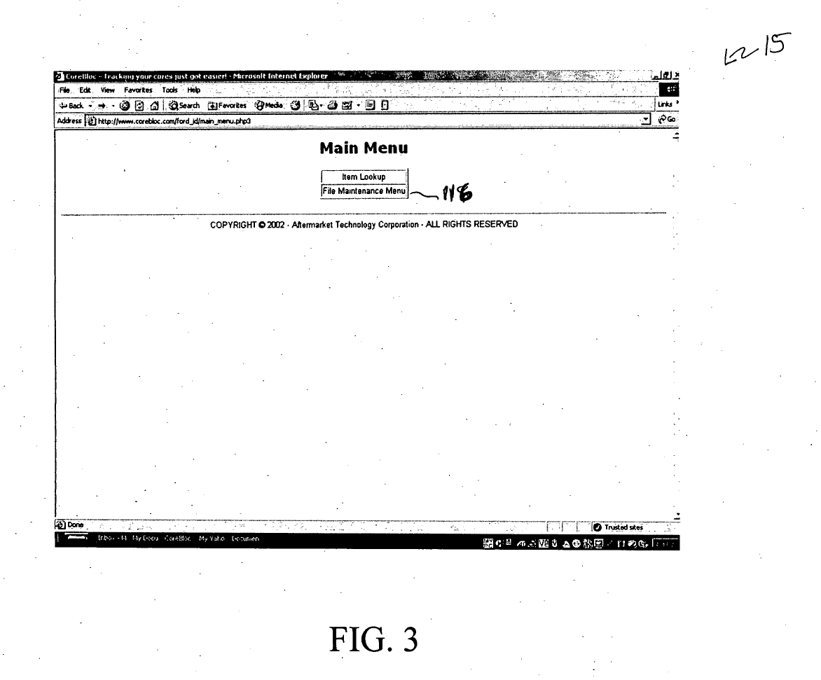

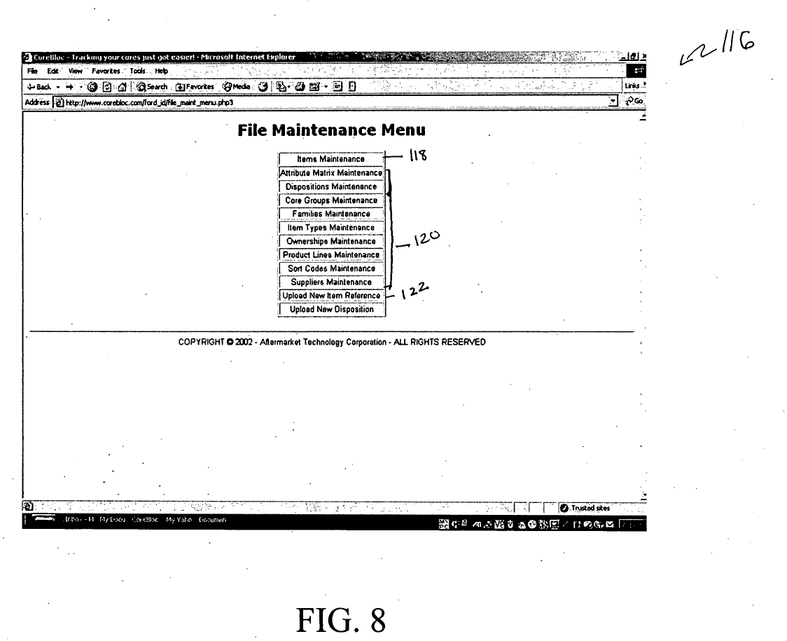

The system 10 further includes an approach for easily maintaining the database 18, through a file maintenance screen 116 (FIG. 8) accessed from the main menu 15 (FIG. 3). From this screen, a user can update any of the data sets of the database. For example, by selecting maintenance items 118, the user can add, modify or delete any item data set. Also, by selecting any of the maintenance selections 120 for core group, families, item types, ownership, product lines, sort codes, or suppliers, the user can edit the corresponding data set (see FIG. 2). The user can, optionally, update the database though the upload options 122. Thus, the system can be easily updated to accommodate new products, or delete others.

The system also can be configured for offline use, in which a database is loaded onto a user's device. In an offline mode, the user's device is a fully independent application that allows read only access to the existing part data for identification purposes only. In an exemplary embodiment, the database, along with corresponding images, are on a host machine and transferred to the user's device, e.g., personal digital assistant, via means known in the art (e.g., synchronization programs, connectable storage devices, flash cards, etc.).

It should be appreciated from the foregoing that the present invention provides an accurate and efficient system and method for efficiently identifying objects, such as transmissions and engines, as well as other manufactured parts, through visual inspection of the unknown object without disassembly or need of substantial familiarity with the system or objects of the object class. Although the invention was described in detail with regard to parts from a particular manufacturer, it is similarly applicable with regard to other types of complex catalogs of parts from other manufacturers.

The system accommodates users of across a wide spectrum of familiarity with “core,” from users from merely able to identify the family of core (e.g., transmission, engine, etc.) to very experienced users. By selecting the wizard block, the user can initiate assisted searching for commodities based upon visual, structural attributes of the part. In this embodiment, the user can select a particular family, e.g., alternators, clutches, transmissions, fuel pumps, engines, etc. Following selection of a particular core family the system presents a web page that presents a set of attribute questions.

The foregoing detailed description of the present invention is provided for the purposes of illustration and is not intended to be exhaustive or to limit the invention to the precise embodiments disclosed. Accordingly, the scope of the present invention is defined by the following claims.

1. A computer system for identifying a part, the system comprising:
a scalable database of identification data sets, each data set descriptive of an item and comprising data for a numbering scheme, a family category, picture files depicting the item, and identification criteria defined from the family category;
a computer-readable medium;
a processor in communication with the computer-readable medium and the database; and
computer readable instructions on the computer readable medium for execution by the processor, the instructions configured to
present an input screen having a plurality of input boxes to a user display screen, including input boxes for input of a number scheme and a family wizard,
receive user input from an input device and retrieve at least one data set descriptive of an item from the database based upon input received,
present a criteria screen, upon receiving input from the user device selecting a family wizard, the criteria screen including identification questions that correlate to the identification criteria for the corresponding family, and
present a results screen, the screen including the at least one data set retrieved based upon input received.

2. A system as defined in claim 1, wherein the data sets descriptive of an item further comprise data selected from a list consisting of ownership, size, sort code, supplier and product line of the item.

3. A system as defined in claim 1, wherein the data sets descriptive of an item further comprise data for ownership, size, sort code, supplier and product line of the item.

4. A system as defined in claim 1, wherein the criteria screen further includes a plurality of drop down menus, each menu associated with a corresponding identification question and listing responses thereto.

5. A system as defined in claim 4, further comprising a user device including the input device and the user display screen.

6. A system as defined in claim 1, wherein the instructions are further configured to present an item screen depicting a data set for a single item.

7. A system as defined in claim 6, wherein the item screen further includes a selectable option for proceeding to a criteria screen for the family to which the item belongs.

8. A method for identifying a part with a computer system, the computer system having a scalable database of identification data sets, each data set descriptive of an item and comprising data for a numbering scheme, a family category, picture files depicting the item, and identification criteria, a computer-readable medium, a processor in communication with the computer-readable medium and the database, and computer readable instructions on the computer readable medium for execution by the processor, the method comprising:
presenting an input screen having a plurality of input boxes to a user display screen, including input boxes for input of a number scheme and a family wizard;
receiving user input from an input device and retrieve at least one data set from the database based upon input received;
presenting a criteria screen, upon receiving input from the user device selecting a family wizard, the criteria screen including identification questions that correlate to the identification criteria for the corresponding family; and
presenting a results screen, the screen including at least one data set and an option to proceed to the criteria screen for the family corresponding to the displayed data set.

9. A method as defined in claim 8, wherein the data sets descriptive of an item further comprise data selected from a list consisting of ownership, size, sort code, supplier and product line of the item.

10. A method as defined in claim 8, wherein the criteria screen further includes a plurality of drop down menus, each menu associated with a corresponding identification question and listing responses thereto.

11. A method as defined in claim 8, wherein the data sets descriptive of an item further comprise data for ownership, size, sort code, supplier and product line of the item.

12. A method as defined in claim 8, wherein the instructions are further configured to present an item screen depicting a single item data set.

13. A method as defined in claim 11, wherein the item screen further includes a selectable option for proceeding to a criteria screen for the family to which the item belongs.

14. A method as defined in claim 8, wherein the criteria screen further includes a plurality of drop down menus, each menu associated with a corresponding identification question and listing responses thereto.

15. A method as defined in claim 14, further comprising a user device including the input device and the user display screen.
